(19) United States
(12) Patent Application Publication
(10) Pub. No.: US 2011/0025173 A1
(43) Pub. Date: Feb. 3, 2011

(54) FITTING STRUCTURE AND METHOD FOR MOUNTING A DECORATIVE PLATE IN THE CORRECT POSITION ON A DOOR OF A HOUSEHOLD APPLIANCE

(75) Inventors: Mehmet Ciyanoglu, Giengen (DE); Karl-Friedrich Laible, Langenau (DE); Helmut Steichele, Lauingen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERATE GMBH, Munich (DE)

(21) Appl. No.: 12/936,211

(22) PCT Filed: Apr. 6, 2009
(86) PCT No.: PCT/EP2009/054090

§ 371 Date: Oct. 4, 2010

(30) Foreign Application Priority Data
Apr. 17, 2008 (DE) 10 2008 019 416.6

(51) Int. Cl. F25D 23/02; B23P 17/04; F16M 13/02; A47B 81/00

(52) U.S. Cl. 312/204; 29/525.01; 248/213.2

(57) ABSTRACT

A fitting structure for fastening a decorative plate to a door of a household appliance. The fitting structure includes a first fitting part fastened to the decorative plate; a second fitting part that meshes with the first fitting part, wherein the second fitting part is fastened to the door; and a spacer that has a first stop surface and a second stop surface that is parallel to the first stop surface. The first stop surfaces rests against an outer edge of the decorative plate and the second stop surface rests against the first fitting part.

The invention relates to a method and a fitting structure suitable for this for mounting a decorative plate in the correct position on a door of a household appliance.

When household appliances are built into kitchen units or are set up adjacent to these, the configuration of the visible front of the appliance is frequently matched to the décor of the doors of the adjacent kitchen units. To achieve a precisely flush arrangement of the unit doors and the visible parts of the appliance front, the latter are generally made up of a number of parts, specifically a door, which has to be mounted in a defined position in relation to a carcass of the appliance in order to close off an interior of the household appliance, and a decorative plate, which is mounted on the door with the aid of a fitting structure at a later stage when the household appliance is set up in its intended location of deployment and adjusted in relation to adjacent unit fronts. In the case of built-in appliances the edge length of the decorative plate is generally a few centimeters longer than that of the door, as the decorative plate not only has to cover the door of the appliance but also the entire recess in which the appliance is set up.

In the published German patent application 10 2005 021 607 A1 a fitting structure is described, by means of which a decorative plate can be mounted in an adjustable manner on the door of a household appliance separated by an intermediate space. The fitting structure comprises an angled piece, one arm of which is fastened to an outer flank of the door, another engaging in the gap between the decorative plate and the door. A bridge fastened to the decorative plate together with the decorative plate defines a holder, in which the other arm engages in a displaceable manner. Since a number of angle/bridge pairs (connecting elements) always have to be mounted at a suitable distance and with a suitable alignment to connect a decorative plate to a door, the flush mounting of such individual connecting elements is necessarily complex.

The object of the invention is to find a fitting structure and a method, which allow a decorative plate to be fastened easily and quickly to the door of a household appliance.

The object is achieved by a fitting structure and a method with the features of claims 1 and 10 respectively. Advantageous embodiments and developments of the invention are described by the subordinate claims.

Because the inventive fitting structure features a spacer in addition to two meshing fitting parts, the first fitting part being provided for fastening to the decorative plate and the second fitting part being provided for fastening to the door, and said spacer features a first stop surface to rest against an outer edge of the decorative plate and a second stop surface parallel to the first stop surface to rest against the first fitting part, it is possible to find the correct mounting position of the first fitting part simply by laying the spacer on the first fitting part and the edge of the decorative plate. The fitter therefore does not have to draw or score the mounting position of the first fitting part separately on the decorative plate. Using a pre-produced spacer means not only that mounting is quicker and without measurement errors but there is also no need to use measuring means, for example a meter rule.

To simplify the assembly of the first fitting part with the decorative plate further, the spacer and the first fitting part preferably feature latching means that interact in a releasable manner to fix the spacer to the first fitting part at least in a direction perpendicular to the stop surfaces. The spacer is preferably made of elastic plastic material or hard rubber, so that it responds in a flexible manner to such a degree that it can be latched by hand without the use of tools and can be unlatched again after the first fitting part has been mounted on the decorative plate.

The fixing of the spacer is also assisted if said spacer preferably features fingers gripping a stirrup of the first fitting part on opposing sides and supporting the second stop surface.

The stirrup preferably also serves to hold a connecting tongue configured on the second fitting part, in other words the stirrup serves at the same time to anchor the spacer and connect it to the second fitting part.

If the fingers of the spacer form two pairs of fingers lying opposite each other on both sides of the stirrup, the connecting tongue expediently engages in an intermediate space between the pairs of fingers. If the spacer is removed after the first fitting part has been mounted on the decorative plate, the space vacated by the fingers ensures that the connecting tongue has sufficient freedom of movement for adjustment purposes.

The connecting tongue can also engage in an intermediate space between the stirrup and the decorative plate or a single intermediate space accommodating the connecting tongue can be limited in one direction by the stirrup and another direction by the above-mentioned fingers.

The fitting structure preferably comprises two first and second fitting parts respectively for mounting along opposing edges of the decorative plate and door.

An adjusting rail can be fastened to the decorative plate between the first fitting parts. The positioning of the adjusting rail is simplified in that it has two markings, each being aligned with a complementary marking on one of the first fitting parts. These markings can in particular be embossed, printed or notched.

Further features and advantages of the invention will emerge from the description which follows of exemplary embodiments with reference to the accompanying figures, in which:

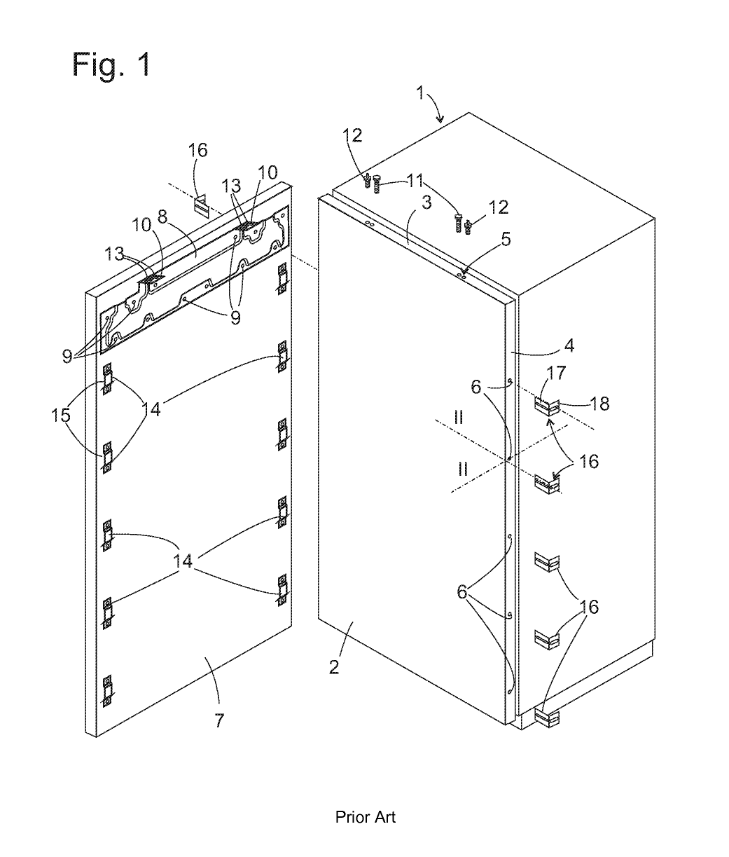

FIG. 1 shows a fitting structure known from the prior art for connecting the door of a household appliance to a decorative plate;

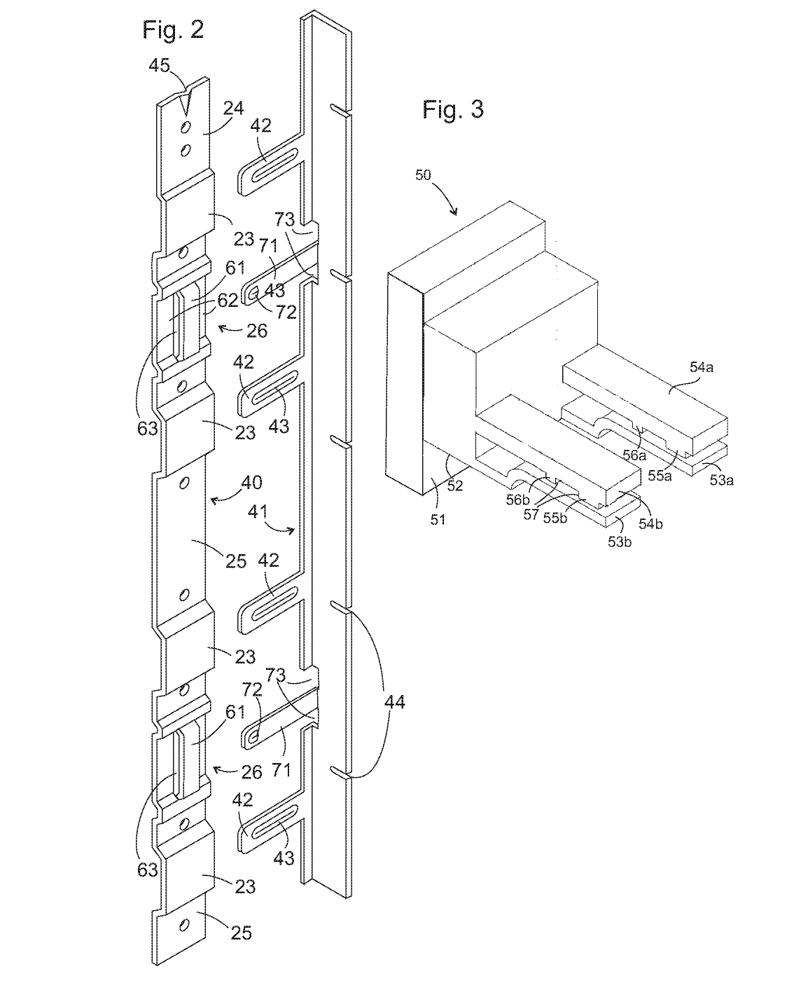

FIG. 2 shows a perspective view of a bridging batten and an angled fastening batten of an inventive fitting structure;

FIG. 3 shows a perspective view of a spacer;

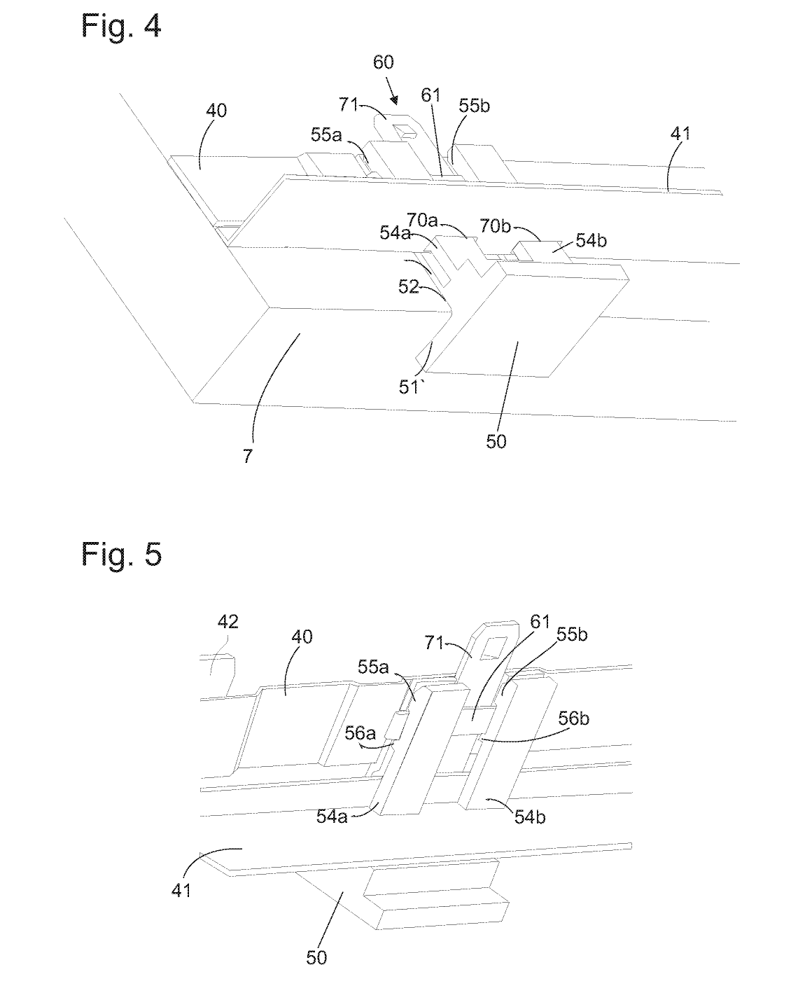

FIG. 4 shows a view of the bridging batten and an angled fastening batten connected together with the aid of the spacer;

FIG. 5 shows a second view of the connected bridging batten and angled fastening batten;

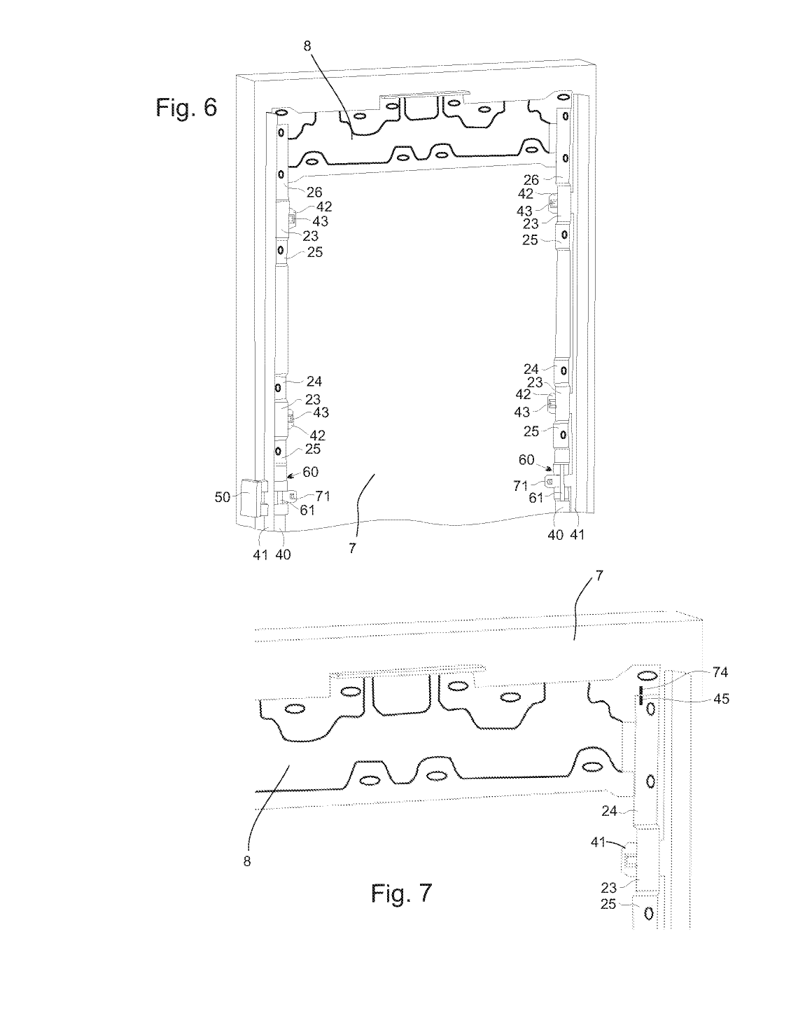

FIG. 6 shows a top view of the rear face of the decorative plate with bridging battens and angled fastening battens attached thereto; and

FIG. 7 shows an enlarged detail from FIG. 6.

To illustrate the problem underlying the invention FIG. 1 shows a fitting structure known from the prior art for connecting the door of a household appliance to a decorative plate, as described for example in the published German patent application DE 10 2005 021 607 A1. The figure shows the perspective view of a household appliance having a carcass 1 and a door 2 hinged thereto in the closed position. A number of threaded blind holes 5, 6 are formed in an upper flank 3 and the lateral flanks 4 of the door 2.

The decorative plate, which is made of wood for example, is shown separated from the appliance-side door 2, on which it is to be mounted. FIG. 1 shows the rear face of the decorative plate 7, which faces the door 2 in the mounted state. In the upper region of the decorative plate 7 an adjusting rail 8 made of sheet metal is fastened with the aid of a number of screws 9. The adjusting rail 8 has a base plate which is stiffened by a flat rib and rests against the decorative plate 7 and two tabs 10 projecting at right angles from the upper edge of the base plate, each having two openings. These openings serve to fasten the decorative plate 7 to the upper flank 3 of the appliance-side door plate 2 with the aid of screws 11 and 12 respectively. The screws 11 are standard screws with a threaded shank and a head. The screws 12 are special screws with a threaded shank, a head and a pin projecting upward from the head. The screws 11, 12 are dimensioned so that their heads do not fit through the openings 13 in the tabs 10 but their shanks do and in the case of the screw 12, its pin. The two screws 12 are first inserted into their assigned threaded holes 5 then the decorative plate is suspended on the screws 12 in such a manner that their pins engage through their assigned openings 13 and the tabs 10 rest on the heads of the screws 12. The height of the decorative plate 7 can be adjusted by turning the screws 12. The lateral position of the decorative plate 7 and its distance from the appliance-side door 2 can be adjusted by displacing the tabs 10 on the heads of the screws 12. When the correct height of the decorative plate 7 has been found, it can be fixed by tightening the screws 11.

A plurality of stirrups 14 bent from sheet metal are screwed to the rear face of the decorative plate 7 adjacent to its lateral edges, each together with the decorative plate 7 defining a gap 15 that is open to the adjacent edge. The gaps 15 are provided in each instance to accommodate a first arm 17 of a mounting elbow 16 formed from sheet metal like the stirrups 14 with a friction lock, a second arm 18 of said mounting elbow 16 being screwed in each instance to one of the threaded holes 6 of one of the lateral flanks 4 of the door 2.

The provision of five pairs of stirrups 14 and mounting elbows respectively on each face of the door 2 is very demanding for a fitter, since the large number of individual elements always brings with it a risk of confusion, incorrect use or loss. There is also a significant mounting outlay, as mutually flush mounting of the stirrups 14 on the decorative plate 7 requires an extremely precise fitting operation.

FIG. 2 shows a perspective view (not to scale) of two fitting parts, a bridging batten 40 and an angled fastening batten 41, according to one embodiment of the present invention.

The bridging batten 40 is a metal strip subdivided by a multiplicity of cranked stages, being provided to be screwed to the rear face of the decorative plate 7 adjacent to a lateral edge. Bearing surfaces 24, 25, 26 and bridging segments 23 alternate in the longitudinal direction of the bridging batten, offset from one another by the cranked stages. The bearing surface 24 forming the upper end of the bridging batten 40 is provided to clamp the adjusting rail 8 when it is screwed to the decorative plate 7; the other bearing surfaces 25, 26 are in direct contact with the decorative plate 7. While the bearing surfaces 25 per se are flat, a latching stirrup 61 flanked by peripheral strips 62 is cut respectively out of the bearing surfaces 26 and released. At least two of the bearing surfaces 26 are present on the bridging batten 40.

The angled fastening batten 41 is an angled profile with two mutually orthogonal arms, the first resting against the decorative plate 7 in the mounted state and the second extending along a lateral flank 4 of the door 2. The first arm features a multiplicity of tongues 42, which are provided to engage in the intermediate spaces between the bridging segments 23 and the decorative plate 7, when the bridging batten 40 is fastened to the decorative plate 7, and latching tongues 71, which extend in a plane that is slightly offset in relation to the plane of the tongues 42 and are provided to engage in an intermediate space spanned by one of the latching stirrups 61. Beads 43 embossed in the tongues 42 ensure a friction-locked connection between the fitting parts, when the tongues 42 are inserted into the intermediate spaces between the bridging segments 23 and the decorative plate 7.

The latching tongues 71 each have a latching nose 72 at their tip, which is provided to latch, after the latching tongue 71 has been inserted, into an intermediate space 63 defined by one of the latching stirrups 61 and the adjacent peripheral strip 62 behind the edge of the latching stirrup 61 facing away from the edge of the decorative plate 7.

Slots 44 are provided in the second arm to be pushed onto screws screwed loosely into the side flank 4 of the door 2, and thus to hold the decorative plate 7 with the fitting parts 40, 41 initially loosely on the door 2, in such a manner that it can be adjusted in the depthways direction of the refrigeration appliance.

FIG. 3 shows a perspective view of a spacer 50 molded from plastic. The spacer 50 has a base plate with a stop surface 51, which is provided to rest against a lateral edge of the decorative plate 7. A block 52 of the spacer 50 projecting beyond the stop surface 51 has a lower surface when viewed in the perspective in FIG. 3, which in the mounted state rests against the rear face of the decorative plate 7. Two pairs of gripping fingers 53a, 54a and 53b, 54b respectively project from the block 52, separated from one another by an intermediate space as wide as the latching tongues 71. These gripping fingers extend in the mounted state through cutouts 73 (see FIG. 2) formed in the angled fastening batten 41 on both sides of the latching tongues 71 and engage in the intermediate space 63 above and below the latching tongue 71.

The fingers 53a, 53b have a cranked profile to facilitate the overcoming of the peripheral strips 62 and insertion into the intermediate space 63.

The gripping fingers 54a, 54b opposite the fingers 53a, 53b each have two latching noses 55a, 56a and 55b, 56b respectively, which, when the spacer 50 is in the mounted state, grip the latching stirrup 61 on both sides without play. Side flanks of the latching noses 55a, 56a, 55b, 56b thus form stop surfaces 57, which determine the distance of the bridging batten 40 from an edge of the decorative plate 7, when the stop surface 51 of the spacer 50 rests against this edge.

With reference to FIG. 2 again, an adjusting mark 45, here in the form of a vertically oriented groove or bead, is embossed at the upper end of the top bearing surface 24. The adjusting rail 8 is provided with complementary adjusting marks 74, the function of which is examined later.

The mounting of the decorative plate 7 on the door 2 with the aid of the fitting parts 40, 41 and the spacer 50 is described below.

A complete fitting structure for mounting the decorative plate 7 comprises two each of the bridging battens 40 and angled fastening battens 41 shown in FIG. 2, a number of spacers 50 corresponding to the number of latching tongues 71 of the angled fastening battens 41, of which there are at least 4, and the adjusting rail 8.

A first mounting step is to insert the latching tongues 71 into the intermediate spaces 63 of the bearing surfaces 26, so that the latching noses 72 latch in place on that side of the latching stirrups 61. In this state the bridging battens 40 and the angled fastening battens 41 can be displaced in relation to one another respectively in their longitudinal direction.

Next the spacers 50 are inserted respectively with their gripping fingers 53, 54 first through the cutouts 73 on both sides of the latching tongues 71 and into the intermediate space 63 on both sides of one of the latching tongues 71. This also fixes the fitting parts 40, 41 in relation to one another in their longitudinal direction. FIGS. 4 and 5 show two perspective views of the inserted spacer 50.

Next the adjusting rail 8 is laid on the upper rear face of the decorative plate 7, which is positioned flat on a base. The two mirror-image modules, each comprising a bridging batten 40, an angled fastening batten 41 and two spacers 50, are also laid on the rear face of the decorative plate 7 along its side edges, the upper bearing surfaces 24 of the bridging battens 40 coming to rest respectively on the adjusting rail 8, as shown in FIG. 6. Because the stop surfaces 51 of the spacers 50 are brought into contact with the edges of the decorative plate 7, the two modules are aligned as mirror images of one another at the same distance from the side edges of the decorative plate 7. Once the two modules have been adjusted to the same level along the side edges of the decorative plate 7, it is possible to start screwing the bridging battens 40 to the decorative plate 7 for the next level of the bearing surfaces 25, 26. Before screwing, the adjusting rail 8, which can still be moved at this point, is aligned with the aid of the adjusting marks 45, 74 so that each adjusting mark 74 on the adjusting rail 8 is a direct extension of the adjusting mark 45 on one of the bridging battens 40. This is shown in the enlarged partial top view of the decorative plate 7 in FIG. 7.

The bearing surfaces 24 are now screwed into place, the adjusting rail 8 being fixed at the same time by being clamped between the bearing surfaces 24 and the decorative plate 7.

In the resulting module made up of the decorative plate 7, fitting parts 8, 40, 41 and spacers 50 all the parts are fixed in relation to one another. At this stage the complete module can be suspended temporarily on the door 2, by pushing the slots 44 of the angled fastening battens 41 onto screws screwed into the side flanks 4 of the door and positioning the adjusting rail 8 on screws 12 screwed into the upper flank of the door as described in relation to FIG. 1.

It is now possible to adjust the position of the door 2 directly in the depthways direction and then tighten the screws; it is also possible to tighten the screws temporarily first and perform a depthways adjustment at a later time.

After the angled fastening battens 41 have been fixed to the side flanks 4 by tightening the screws, the vertical position of the decorative plate 7 is adjusted with the aid of the screws 12 so that the weight of the decorative plate 7 is removed from the spacers 50 and said spacers 50 can be withdrawn from the intermediate spaces 63. Removing the spacers 50 allows the decorative plate 7 to be adjusted vertically. Vertical adjustment is performed with the aid of the screws 12 and finally fixed with the aid of the screws 11, as described with reference to FIG. 1.

1-14. (canceled)

15. A fitting structure for fastening a decorative plate to a door of a household appliance, the fitting structure comprising:
a first fitting part fastened to the decorative plate;
a second fitting part that meshes with the first fitting part, the second fitting part fastened to the door; and
a spacer having a first stop surface and a second stop surface that is parallel to the first stop surface;
wherein the first stop surfaces rests against an outer edge of the decorative plate; and
wherein the second stop surface rests against the first fitting part.

16. The fitting structure of claim 15, wherein the spacer and the first fitting part have latching means that interact in a releasable manner to fix the spacer to the first fitting part at least in a direction perpendicular to the first and second stop surfaces.

17. The fitting structure of claim 16, wherein the spacer has fingers that grip a stirrup of the first fitting part on opposing sides and that support the second stop surface.

18. The fitting structure of claim 17, wherein the second fitting part has a connecting tongue that is held on the stirrup.

19. The fitting structure of claim 18, wherein the fingers of the spacer form two pairs of fingers lying opposite each other on both sides of the stirrup, and wherein the connecting tongue engages in an intermediate space between the two pairs of fingers.

20. The fitting structure of claim 18, wherein the connecting tongue engages in an intermediate space between the stirrup and the decorative plate.

21. The fitting structure of claim 15, wherein the fitting structures comprises two first fitting parts and two second fitting parts for mounting along opposing edges of the decorative plate and the door.

22. The fitting structure of claim 21, further comprising an adjusting rail fastened to the decorative plate between the two first fitting parts, the adjusting rail having two markings, wherein each of the two markings is aligned with a complementary marking on one of the two first fitting parts.

23. The fitting structure of claim 22, wherein the two markings are one of embossed, printed and notched.

24. A household appliance, comprising:
a door;
a fitting structure; and
a decorative plate supported on the door by the fitting structure, the fitting structure comprising:
a first fitting part fastened to the decorative plate;
a second fitting part that meshes with the first fitting part, the second fitting part fastened to the door; and
a spacer having a first stop surface and a second stop surface that is parallel to the first stop surface;
wherein the first stop surfaces rests against an outer edge of the decorative plate; and
wherein the second stop surface rests against the first fitting part.

25. The household appliance of claim 24, wherein the household appliance is a household refrigeration appliance.

26. A method for mounting a decorative plate on a door of a household appliance by means of a fitting structure, the fitting structure having a first fitting part fastened to the decorative plate, a second fitting part that meshes with the first fitting part, the second fitting part fastened to the door, and a spacer having a first stop surface and a second stop surface that is parallel to the first stop surface, wherein the first stop surfaces rests against an outer edge of the decorative plate, and wherein the second stop surface rests against the first fitting part, the method comprising:
joining together the first and second fitting parts;
placing the first and second fitting parts on the decorative plate in a position in which the first stop surface of the spacer rests against an outer edge of the decorative plate and the second stop surface rests against the first fitting part;
fastening the first fitting part to the decorative plate; and
fastening the second fitting part to the door.

27. The method of claim 26, further comprising removing the spacer after fastening the first fitting part to the decorative plate.

28. The method of claim 26, wherein the placing step and the fastening the second fitting part to the door step are performed on two opposing outer edges of the decorative plate; and wherein subsequently an adjusting rail is fastened to the decorative plate between two first fastening means.

29. The method of claim 28, wherein, before fastening the adjusting rail, markings formed on the adjusting rail and the first fitting part are aligned with one another.
